(19) United States
(12) Patent Application Publication
(10) Pub. No.: US 2023/0194072 A1
(43) Pub. Date: Jun. 22, 2023

(54) INDUCTION LIGHT-EMITTING FLOOR MAT

(71) Applicant: Yunrong MENG, Guiping (CN)

(72) Inventor: Yunrong MENG, Guiping (CN)

(21) Appl. No.: 18/149,885

(22) Filed: Jan. 4, 2023

(51) Int. Cl. F21V 23/04; A47G 27/02; F21V 33/00; F21S 4/22

(52) U.S. Cl. CPC F21V 23/0471; A47G 27/0243; F21V 33/006; F21S 4/22; F21V 23/0464; F21Y 2115/10

(57) ABSTRACT

The present invention relates to the field of floor mats, in particular to an induction light-emitting floor mat, including an induction box body, a floor mat body and a waterproof light strip, wherein a rechargeable battery, a main control module U2, a human body infrared sensor module and a photosensitive module are arranged in the induction box body. The floor mat is installed at a place where you go out, will light up when you approach it and also illuminates when you go home, which is convenient for taking keys or looking for other lamp switches. The floor mat can also be used as a night light indoors, and will automatically light up when you get up.

### TECHNICAL FIELD

The present invention relates to the field of floor mats, in particular to an induction light-emitting floor mat.

### BACKGROUND

Nowadays, the floor mats are mainly used to decorate and clean soles. It is difficult to find the keyhole when you get home at night to open the door with the key. When you go to the bathroom at dark, no light can be provided to find the switch to turn on the light. It is also very troublesome to lay out lines if installing lamps, and some lamps also take up space.

Many people have the habit of getting up in the night to urinate, but turning on the lights at night may disturb their families and affect their rest; and if the lights are not turned on, people may bump into obstacles and cause physical injury. Some families also use night lights to illuminate, although the night lights are not powerful, a waste of electricity will still be caused due to continuous illumination throughout the night. In addition, according to some research results, it is difficult for people to fall into a deep sleep in an environment with light, and long-term exposure to night light affect the quality of sleep.

### SUMMARY

In order to solve the above problems, the present invention provides an induction light-emitting floor mat that is installed at a place where you go out, will light up when you approach it and also illuminates when you go home, which is convenient for taking keys or looking for other lamp switches. The floor mat can also be used as a night light indoors, and will automatically light up when you get up.

In order to realize the above purposes, the technical solution adopted in the present invention is as follows: an induction light-emitting floor mat, including an induction box body, a floor mat body, and a waterproof light strip fixed on an outer edge of the floor mat body, wherein a rechargeable battery, a main control module U2, a human body infrared sensor module used for sensing human body heat infrared information, and a photosensitive module used for sensing light brightness of an environment are arranged in the induction box body; the human body infrared sensor module, the photosensitive module and the rechargeable battery are all electrically connected to the main control module U2; and a light strip output interface is formed in the main control module U2 and electrically communicates with a light strip input interface in the waterproof light strip via a transmission line.

Further, an induction hole corresponding to the human body infrared sensor module and a photosensitive hole corresponding to the photosensitive module are formed in the surface of the induction box body, wherein the human body infrared induction module extends out of the induction hole, and the photosensitive module extends out of the photosensitive hole.

Further, the main control module U2 is also provided with a charging interface and a charging protection circuit; the charging protection circuit includes a first resistor R1, a charging IC, a fourth resistor R4, a fourth capacitor C4, a state-of-charge light-emitting diode D1, and a full-charge state light-emitting diode D2, where a second pin PROG of the charging IC is grounded via the first resistor R1, a fourth pin VCC of the charging IC is grounded via the fourth capacitor C4, the fourth pin VCC is connected to the charging interface at the same time, and a fifth pin BAT of the charging IC is electrically connected to the rechargeable battery; an eighth pin CE of the charging IC is connected to the charging interface, and the eighth pin CE of the charging IC is respectively connected to positive electrodes of the state-of-charge light emitting diode D1 and the full-charge state light-emitting diode D2 via the fourth resistor R4; a negative electrode of the state-of-charge light emitting diode D1 is connected to a seventh pin CHRG of the charging IC, and a negative electrode of the full-charge state light-emitting diode D2 is connected to a sixth pin STDBY of the charging IC.

Further, a power supply voltage regulator circuit is also included, where the rechargeable battery is connected to an input end of the power supply voltage regulator circuit, and an output end of the power supply voltage regulator circuit is electrically connected to the main control module U2. Further, the power supply voltage regulator circuit includes a voltage regulator chip U1, a first capacitor C1, a second capacitor C2 and a third capacitor C3, where a Vin pin of the voltage regulator chip U1 is grounded via the first capacitor C1, and a Vout pin of the voltage regulator chip U1 is grounded via the second capacitor C2 and the third capacitor C3, respectively; the rechargeable battery is connected to the Vin pin of the voltage regulator chip U1, and the Vout pin of the voltage regulator chip U1 is electrically connected to a first pin of the main control module U2.

Further, a light strip drive circuit is also included, where an output end of the main control module U2 is electrically connected to the light strip output interface via the light strip drive circuit.

Further, the light strip drive circuit includes a second resistor R2, a third resistor R3 and a metal oxide semiconductor (MOS) transistor Q1, where a fifth pin of the main control module U2 is grounded via the second resistor R2, a sixth pin of the main control module U2 is grounded via the third resistor R3, the fifth pin of the main control module U2 is connected to a G pole of the MOS transistor Q1, an S pole of the MOS transistor Q1 is grounded, and a D pole of the MOS transistor Q1 is electrically connected to the light strip output interface.

Further, a time regulation potentiometer is also included, which is electrically connected to an eighth pin of the main control module U2, where a regulation knob sleeved on the time regulation potentiometer and used for regulating a resistance value of the time regulation potentiometer is arranged outside the induction box body.

Further, a magnetic base fixed on a wall surface is also included, where a magnetic magnet is further arranged in the induction box body, and the induction box body is adsorbed onto the surface of the magnetic base via the magnetic magnet.

Further, the surface of the magnetic base is also provided with a hook, the outer surface of the induction box body is provided with a hanging hole, and the magnetic base is assembled with the hanging hole of the induction box body via the hook.

The present invention has the beneficial effects as follows: this induction light-emitting floor mat can be used as a floor mat and also as an induction light at the same time. The floor mat is installed at a place where you go out, and will light up when you approach it and also illuminates when you go home, which is convenient for taking keys or looking for other lamp switches. The floor mat can also be used as a night light indoor, and will automatically light up when you get up.

When installing the induction floor mat, it only needs to lay the floor mat body at the entrance and exit of the door, and the waterproof light strip is assembled together with the floor mat body. When charging, the light strip output interface can be unplugged so that the induction box body is separately charged or the rechargeable battery is replaced. When the floor mat body is dirty, the light strip output interface can also be unplugged to clean the floor mat body separately.

The human body infrared sensor module can sense the heat infrared information approaching human body and then the waterproof light strip is started to turn on the light. The photosensitive module can sense the light of the environment to determine if the human infrared sensor module needs to be activated. When the ambient light is bright and no lighting is needed, the human body infrared sensor module is not started; and the induction can only be activated in a dark light environment, which can greatly improve the battery life.

### BRIEF DESCRIPTION OF DRAWINGS

FIG. 1 is a schematic structural diagram of an induction light-emitting floor mat.

FIG. 2 is a specific circuit schematic diagram of a charging interface and a charging protection circuit.

FIG. 3 is a specific circuit schematic diagram of a main control module U2, a power supply voltage regulator circuit, and a light strip drive circuit.

Reference numeral listing: Human Body Infrared Sensor Module 1, Photosensitive Module 2, Waterproof Interface 3, Floor Mat Body 4, Waterproof Light Strip 5, Regulation Knob 6, Control Switch 7, Charging Interface 8, Fixing Base 9, Hook 11, Induction Box Body 12, Power Supply Voltage Regulator Circuit 13, Time Regulation Potentiometer 14, Light Strip Drive Circuit 15, and Charging Protection Circuit 16.

### DETAILED DESCRIPTION OF THE EMBODIMENTS

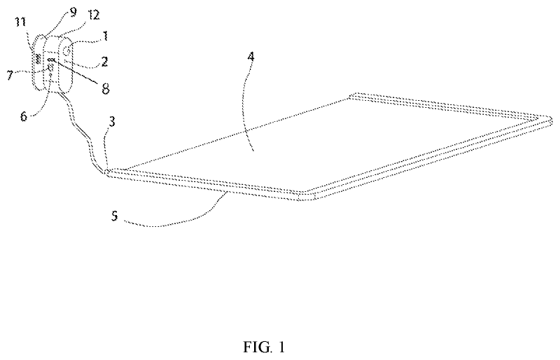

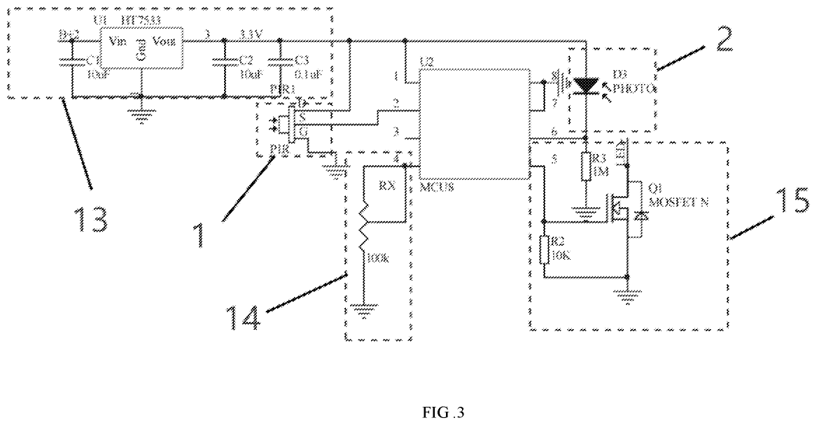

Referring to FIGS. 1-3, the present invention relates to an induction light-emitting floor mat, including an induction box body 12, a floor mat body 4, and a waterproof light strip 5 fixed on an outer edge of the floor mat body 4, wherein a rechargeable battery, a main control module U2, a human body infrared sensor module 1 used for sensing human body heat infrared information, and a photosensitive module 2 used for sensing light brightness of an environment are arranged in the induction box body 12; the human body infrared sensor module 1, the photosensitive module 2 and the rechargeable battery are all electrically connected to the main control module U2; and a light strip output interface is formed in the main control module U2 and electrically communicates with a light strip input interface in the waterproof light strip 5 via a transmission line.

This induction light-emitting floor mat can be used as a floor mat and also as an induction light at the same time. The floor mat is installed at a place where you go out, will light up when you approach it, and also illuminates when you go home, which is convenient for taking keys or looking for other lamp switches. The floor mat can also be used as a night light indoors, and will automatically light up when you get up.

When installing the induction floor mat, it only needs to lay the floor mat body at the entrance and exit of the door, and the waterproof light strip 5 is assembled together with the floor mat body 4. When charging, the light strip output interface can be unplugged so that the induction box body 12 is separately charged or the rechargeable battery is replaced. When the floor mat body 4 is dirty, the light strip output interface can also be unplugged to clean the floor mat body 4 separately.

The human body infrared sensor module 1 can sense the heat infrared information approaching a human body and then the waterproof light strip 5 is started to turn on the light. The photosensitive module 2 can sense the light of the environment to determine if the human body infrared sensor module 1 needs to be activated. When the ambient light is bright and no lighting is needed, the human body infrared sensor module 1 is not started; and the induction can only be activated in a dark light environment, which can greatly improve the battery life.

Further, an induction hole corresponding to the human body infrared sensor module 1 and a photosensitive hole corresponding to the photosensitive module 2 are formed in the surface of the induction box body 12, wherein the human body infrared sensor module 1 extends out of the induction hole, and the photosensitive module 2 extends out of the photosensitive hole.

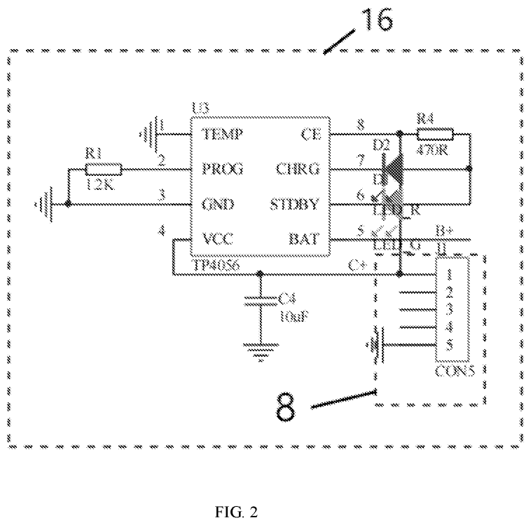

Further, the main control module U2 is also provided with a charging interface 8 and a charging protection circuit 16; the charging protection circuit 16 includes a first resistor R1, a charging IC (corresponding to U3 in FIG. 2, with the specific model of TP4056), a fourth resistor R4, a fourth capacitor C4, a state-of-charge light-emitting diode D1, and a full-charge state light-emitting diode D2, wherein a second pin PROG of the charging IC is grounded via the first resistor R1, a fourth pin VCC of the charging IC is grounded via the fourth capacitor C4, the fourth pin VCC is connected to the charging interface 8 at the same time, and a fifth pin BAT of the charging IC is electrically connected to the rechargeable battery; an eighth pin CE of the charging IC is connected to the charging interface 8, and the eighth pin CE of the charging IC is respectively connected to positive electrodes of the state-of-charge light-emitting diode D1 and the full-charge state light-emitting diode D2 via the fourth resistor R4; a negative electrode of the state-of-charge light emitting diode D1 is connected to a seventh pin CHRG of the charging IC, and a negative electrode of the full-charge state light-emitting diode D2 is connected to a sixth pin STDBY of the charging IC.

The TP4056 charging protection circuit 16 is a single-cell lithium battery constant current/constant voltage linear charger, which works mainly to convert the 5V voltage of a mobile phone charger into a 4.2V voltage to charge the lithium battery, and a maximum charging current of 1A can be provided.

Further, a power supply voltage regulator circuit 13 is also included, where the rechargeable battery is connected to an input end of the power supply voltage regulator circuit 13, and an output end of the power supply voltage regulator circuit 13 is electrically connected to the main control module U2. Further, the power supply voltage regulator circuit 13 includes a voltage regulator chip U1, a first capacitor C1, a second capacitor C2 and a third capacitor C3, wherein a Vin pin of the voltage regulator chip U1 is grounded via the first capacitor C1, and a Vout pin of the voltage regulator chip U1 is grounded via the second capacitor C2 and the third capacitor C3, respectively; the rechargeable battery is connected to the Vin pin of the voltage regulator chip U1, and the Vout pin of the voltage regulator chip U1 is electrically connected to a first pin of the main control module U2.

The power supply voltage regulator circuit 13 is a linear voltage regulator that uses transistors or field effect transistors (FETs) operating in its saturation region to subtract excess voltage from the applied input voltage to produce a regulated output voltage.

Further, a light strip drive circuit 15 is also included, where an output end of the main control module U2 is electrically connected to the light strip output interface via the light strip drive circuit 15. Further, the light strip drive circuit 15 includes a second resistor R2, a third resistor R3 and a metal oxide semiconductor (MOS) transistor Q1, wherein a fifth pin of the main control module U2 is grounded via the second resistor R2, a sixth pin of the main control module U2 is grounded via the third resistor R3, the fifth pin of the main control module U2 is connected to a G pole of the MOS transistor Q1, an S pole of the MOS transistor Q1 is grounded, and a D pole of the MOS transistor Q1 is electrically connected to the light strip output interface.

Further, a time regulation potentiometer 14 is also included, which is electrically connected to an eighth pin of the main control module U2, wherein a regulation knob 6 sleeved on the time regulation potentiometer 14 and used for regulating a resistance value of the time regulation potentiometer 14 is arranged outside the induction box body 12.

Further, a magnetic base fixed on a wall surface is also included, where a magnetic magnet is further arranged in the induction box body 12, and the induction box body 12 is adsorbed onto the surface of the magnetic base via the magnetic magnet.

Further, the surface of the magnetic base is also provided with a hook 11, the outer surface of the induction box body 12 is provided with a hanging hole, and the magnetic base is assembled with the hanging hole of the induction box body 12 via the hook 11.

This induction light-emitting floor mat can be used as a floor mat and also as an induction light at the same time. The floor mat is installed at a place where you go out, will light up when you approach it, and also illuminates when you go home, which is convenient for taking keys or looking for other lamp switches. The floor mat can also be used as a night light indoors, and will automatically light up when you get up.

The overall working principle and assembly principle are as follows: when installing the induction floor mat, it only needs to lay the floor mat body 4 at the entrance and exit of the door, the waterproof light strip 5 is assembled together with the floor mat body 4, and the magnetic base is fixed to the wall where people walk. The magnetic base can be used as an armature iron. The induction box body 12, installed with a magnetic magnet, can be directly attached to the magnetic base, or the induction box body 12 can be inserted onto the hook 11.

When charging, the light strip output interface (a waterproof interface 3) can be unplugged so that the induction box body 12 is separately charged or the rechargeable battery is replaced. When the floor mat body 4 is dirty, the light strip output interface (also the waterproof interface 3) can also be unplugged to clean the floor mat body 4 separately. Thus, the induction box body 12 will not be touched when cleaning, and if the induction box body 12 is charged or the rechargeable battery is replaced, it is unnecessary to bring the dirty floor mat body 4 together.

After the floor mat body 4 and the induction box body 12 are installed, a control switch 7 is turned on to activate the induction mode. The human body infrared sensor module 1 can sense the heat infrared information approaching a human body and then the waterproof light strip 5 is started to turn on the light. The photosensitive module 2 can sense the light of the environment to determine if the human body infrared sensor module 1 needs to be activated. When the ambient light is bright and no lighting is needed, the human body infrared sensor module 1 is not started; and the induction can only be activated in a dark light environment, which can greatly improve the battery life.

The charging interface 8 can charge the rechargeable battery when the rechargeable battery is dead, or the rechargeable battery can be replaced. The advantage of rechargeable batteries is that there is no need to rearrange lines, which saves labor and is easy in installation. In addition, when each person needs a different lighting time, the regulation knob 6 can be turned to adjust the resistance value of the time regulation potentiometer 14, so as to choose different lighting times.

The above embodiments only describe the preferred embodiments of the present invention, and is not intended to limit the scope of the present invention. Without departing from the design spirit of the present invention, various modifications and improvements made by those of ordinary engineering skill in the art to the technical solution of the present invention shall fall within the scope of protection determined by the claims of the present invention.

What is claimed is:

1. An induction light-emitting floor mat, comprising an induction box body, a floor mat body, and a waterproof light strip fixed on an outer edge of the floor mat body, wherein a rechargeable battery, a main control module U2, a human body infrared sensor module used for sensing human body heat infrared information, and a photosensitive module used for sensing light brightness of an environment are arranged in the induction box body; the human body infrared sensor module, the photosensitive module and the rechargeable battery are all electrically connected to the main control module U2; and a light strip output interface is formed in the main control module U2, and electrically communicates with a light strip input interface in the waterproof light strip via a transmission line.

2. The induction light-emitting floor mat according to claim 1, wherein an induction hole corresponding to the human body infrared sensor module and a photosensitive hole corresponding photosensitive module are formed in the surface of the induction box body, where the human body infrared sensor module extends out of the induction hole, and the photosensitive module extends out of the photosensitive hole.

3. The induction light-emitting floor mat according to claim 2, wherein the main control module U2 is also provided with a charging interface and a charging protection circuit; the charging protection circuit comprises a first resistor R1, a charging IC, a fourth resistor R4, a fourth capacitor C4, a state-of-charge light-emitting diode D1, and a full-charge state light-emitting diode D2, where a second pin PROG of the charging IC is grounded via the first resistor R1, a fourth pin VCC of the charging IC is grounded via the fourth capacitor C4, the fourth pin VCC is connected to the charging interface at the same time, and a fifth pin BAT of the charging IC is electrically connected to the rechargeable battery; an eighth pin CE of the charging IC is connected to the charging interface, and the eighth pin CE of the charging IC is respectively connected to positive electrodes of the state-of-charge light-emitting diode D1 and the full-charge state light-emitting diode D2 via the fourth resistor R4; a negative electrode of the state-of-charge light-emitting diode D1 is connected to a seventh pin CHRG of the charging IC, and a negative electrode of the full-charge state light-emitting diode D2 is connected to a sixth pin STDBY of the charging IC.

4. The induction light-emitting floor mat according to claim 1, further comprising a power supply voltage regulator circuit, wherein the rechargeable battery is connected to an input end of the power supply voltage regulator circuit, and an output end of the power supply voltage stabilization circuit is electrically connected to the main control module U2.

5. The induction light-emitting floor mat according to claim 5, wherein the power supply voltage regulator circuit comprises a voltage regulator chip U1, a first capacitor C1, a second capacitor C2 and a third capacitor C3, where a Vin pin of the voltage regulator chip U1 is grounded via the first capacitor C1, and a Vout pin of the voltage regulator chip U1 is grounded via the second capacitor C2 and the third capacitor C3, respectively; the rechargeable battery is connected to the Vin pin of the voltage regulator chip U1, and the Vout pin of the voltage regulator chip U1 is electrically connected to a first pin of the main control module U2.

6. The induction light-emitting floor mat according to claim 5, further comprising a light strip drive circuit, wherein an output end of the main control module U2 is electrically connected to the light strip output interface via the light strip drive circuit.

7. The induction light-emitting floor mat according to claim 6, wherein the light strip drive circuit comprises a second resistor R2, a third resistor R3 and a metal oxide semiconductor (MOS) transistor Q1, where a fifth pin of the main control module U2 is grounded via the second resistor R2, a sixth pin of the main control module U2 is grounded via the third resistor R3, the fifth pin of the main control module U2 is connected to a G pole of the MOS transistor Q1, an S pole of the MOS transistor Q1 is grounded, and a D pole of the MOS transistor Q1 is electrically connected to the light strip output interface.

8. The induction light-emitting floor mat according to claim 1, further comprising a time regulation potentiometer, which is electrically connected to an eighth pin of the main control module U2, wherein a regulation knob sleeved on the time regulation potentiometer and used for regulating a resistance value of the time regulation potentiometer is arranged outside the induction box body.

9. The induction light-emitting floor mat according to claim 1, further comprising a magnetic base fixed on a wall surface, wherein a magnetic magnet is further arranged in the induction box body, and the induction box body is adsorbed onto the surface of the magnetic base via the magnetic magnet.

10. The induction light-emitting floor mat according to claim 1, wherein the surface of the magnetic base is also provided with a hook, the outer surface of the induction box body is provided with a hanging hole, and the magnetic base is assembled with the hanging hole of the induction box body via the hook.
